(19) United States
(12) Patent Application Publication
(10) Pub. No.: US 2004/0111634 A1
(43) Pub. Date: Jun. 10, 2004

(54) Security permissions for an integrated dispatch system

(76) Inventors: Robert M. Ingman, (US); Charles E. Reddick, Palatka, FL (US)

Correspondence Address: Scott P. Zimmerman, P.O. Box 3822, Cary, NC, 27519, US

(21) Appl. No.: 10/160,645

(22) Filed: May 31, 2002

(51) Int. Cl. H04L 9/00

(52) U.S. Cl. 713/201

(57) ABSTRACT

Methods and systems are disclosed for enhancing an Integrated Dispatch System with local and system security permissions. The local security permissions deter administrators from modifying system-wide data. Once the local security permissions are established, the local security permissions permit modification of data specific to a geographic jurisdiction. The local security permissions deter modification of data not specific to the geographic jurisdiction. Once the local security permissions are established, the Integrated Dispatch System dispatches work orders for maintenance of a telecommunications network.

### NOTICE OF COPYRIGHT PROTECTION

A portion of the disclosure of this patent document and its figures contain material subject to copyright protection. The copyright owner has no objection to the facsimile reproduction by anyone of the patent document or the patent disclosure, but the copyright owner otherwise reserves all copyrights whatsoever.

### BACKGROUND OF THE INVENTION

1. Field of the Invention

This invention generally relates to computers and to telecommunications and, more particularly, to methods and to systems for enhancing an Integrated Dispatch System with differing levels of security permissions.

2. Description of the Related Art

When a telecommunications network requires maintenance, an Integrated Dispatch System manages dispatch of work orders. The Integrated Dispatch System is a computer program that receives an electronic work order and dispatches that work order. Because the Integrated Dispatch System is a computer program, the Integrated Dispatch System is managed by a team of administrators. The Integrated Dispatch System typically operates from a central server location, and each administrator is responsible for managing the data and parameters for that administrator's area. One administrator, for example, is responsible for the data and parameters used for dispatching work orders in Louisiana, while another administrator is responsible for the data and parameters used for dispatching work orders in North Carolina.

Although there are multiple administrators, the Integrated Dispatch System only has one level of security permissions. Once an administrator is authorized, the security permissions allow the administrator to make system-wide, global changes to the Integrated Dispatch System. This single level of security permissions authorizes each administrator to make any transaction in the Integrated Dispatch System, even if that transaction could affect all geographic areas.

This single level of security permissions causes problems. Because each administrator is authorized to make global, system-wide changes, an administrator may inadvertently access the wrong area of the Integrated Dispatch System and make unintended global changes. The administrator responsible for the Louisiana data and parameters, for example, can inadvertently make changes to the North Carolina data and parameters. These inadvertent changes usually occur when an administrator makes a selection using a drop-down list box. The administrator places a computer cursor, clicks a mouse, and a listing of options appears. While the administrator may only intend to view the choices, the administrator may inadvertently select an option and make a system-wide change or area-wide change to the Integrated Dispatch System. The effects of this inadvertent change may take hours to discover, yet, in the meantime, the dispatch of thousands of work orders is affected.

There is, accordingly, a need for an Integrated Dispatch System that deters administrators from making inadvertent global changes, a need for an Integrated Dispatch System that deters an administrator from making changes that stray beyond their assigned area, and, yet, a need for an Integrated Dispatch System that preserves the authority of some system administrators to make global, system-wide modifications.

### BRIEF SUMMARY OF THE INVENTION

The aforementioned problems are reduced by an enhanced Integrated Dispatch System. The integrated Dispatch System comprises computer programs and computer systems that manage dispatch of work orders in a telecommunications network. This invention creates two levels of administrators, a “Local Administrator” and a “System Administrator.” Each Local Administrator is assigned a geographic area, and “Local Security Permissions” deter or prevent one Local Administrator from intruding upon the authority of another Local Administrator. A higher, second level of security permissions, termed “System Security Permissions,” applies to the System Administrators. Each Local Administrator is assigned a geographic jurisdiction, and the Local Security Permissions permit the Local Administrator to modify data and parameters pertaining to the Local Administrator's geographic jurisdiction. The Local Security Permissions, however, deter or prevent a Local Administrator from making any data or parameter modifications that are outside the Local Administrator's geographic jurisdiction and are the responsibility of another administrator. These differing levels of security permissions also deter Local Administrators from intruding upon the authority of System Administrators. The System Security Permissions, conversely, permit the System Administrator to modify data and parameters across geographic jurisdictions. The System Security Permissions thus permit the System Administrator to modify system-wide parameters that apply to one or more geographic jurisdictions. These differing levels of security permissions thus deter a Local Administrator from inadvertently making global changes.

One embodiment of this invention is an Integrated Dispatch System product. The Integrated Dispatch System manages the dispatch of work orders for maintenance of a telecommunications network. The Integrated Dispatch System has local security permissions and system security permissions. The local security permissions permit a local administrator to control local parameters that are specific to a geographic jurisdiction, whereas the system security permissions permit a system administrator to control system-wide parameters that apply to more than one geographic jurisdiction.

Another embodiment describes a method for enhancing an Integrated Dispatch System with more than one level of security permissions. The method establishes local security permissions and system security permissions in the Integrated Dispatch System. The local security permissions permit modification of data specific to a geographic jurisdiction, while the local security permissions deter modification of data not specific to the geographic jurisdiction. The system security permissions permit modification of data across geographic jurisdictions. Once the local security permissions and system security permissions are established, the Integrated Dispatch System electronically dispatches a work order for maintenance of a telecommunications network.

Another embodiment describes a computer system. An integrated dispatch system is stored in a memory device. The integrated dispatch system manages the dispatch of work orders in a telecommunications network. The integrated dispatch system has at least two levels of security permissions, local security permissions and system security permissions. The local security permissions permit modification of data specific to a geographic jurisdiction, while the local security permissions deter modification of data not specific to the geographic jurisdiction. The system security permissions, however, permit a systems administrator to control system-wide data as well as data specific to one or more geographic jurisdiction. The system security permissions, therefore, permit modification of data across geographic jurisdictions. The computer system also includes a processor communicating with the memory device.

### BRIEF DESCRIPTION OF THE SEVERAL VIEWS OF THE DRAWINGS

These and other features, aspects, and advantages of this invention are better understood when the following Detailed Description of the Invention is read with reference to the accompanying drawings, wherein:

FIG. 1 is a block diagram showing an embodiment of the Integrated Dispatch System that resides in a computer system;

FIG. 2 is a block diagram further illustrating an operating environment for the Integrated Dispatch System;

FIG. 3 is a Graphical User Interface showing the Local Security Permissions;

FIG. 4 is a schematic illustrating a Graphical User Interface for a Technical Support Center associate; and

FIGS. 5 and 6 are flowcharts describing one method of enhancing an Integrated Dispatch System with security permissions.

### DETAILED DESCRIPTION OF THE INVENTION

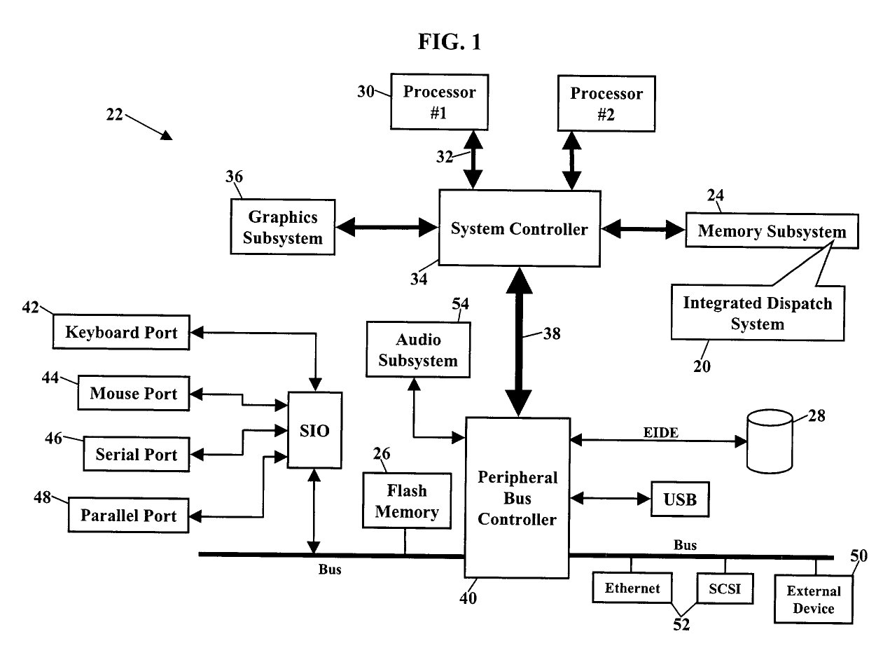

FIG. 1 depicts one exemplary operating environment for an embodiment of this invention. This embodiment of an Integrated Dispatch System 20 includes a computer program that establishes two levels of security permissions. “Local Security Permissions” apply to Local Administrators, while a higher, second level of security permissions, termed “System Security Permissions,” applies to System Administrators. These two levels of security permissions deter Local Administrators from intruding upon the authority of other Local Administrators and of System Administrators. The Local Security Permissions permit a Local Administrator to modify data and parameters pertaining to the Local Administrator's geographic jurisdiction. The Local Security Permissions, however, deter the Local Administrator from making any data or parameter modifications that are outside the Local Administrator's geographic jurisdiction and are the responsibility of another Local Administrator. The System Security Permissions permit the System Administrator to modify data and parameters across geographic jurisdictions.

FIG. 1 is a block diagram showing the Integrated Dispatch System 20 residing in a computer system 22. The Integrated Dispatch System 20 operates within a system memory device. The Integrated Dispatch System 20, for example, is shown residing in a memory subsystem 24. The Integrated Dispatch System 20, however, could also reside in flash memory 26 or peripheral storage device 28. The computer system 22 also has one or more central processors 30 executing an operating system. The operating system, as is well known, has a set of instructions that control the internal functions of the computer system 22. A system bus 32 communicates signals, such as data signals, control signals, and address signals, between the central processor 30 and a system controller 34 (typically called a “Northbridge”). The system controller 34 provides a bridging function between the one or more central processors 30, a graphics subsystem 36, the memory subsystem 24, and a PCI (Peripheral Controller Interface) bus 38. The PCI bus 38 is controlled by a Peripheral Bus Controller 40. The Peripheral Bus Controller 40 (typically called a “Southbridge”) is an integrated circuit that serves as an input/output hub for various peripheral ports. These peripheral ports could include, for example, a keyboard port 42, a mouse port 44, a serial port 46 and/or a parallel port 48 for a video display unit, one or more external device ports 50, and networking ports 52 (such as SCSI or Ethernet). The Peripheral Bus Controller 40 could also include an audio subsystem 54. Those of ordinary skill in the art understand that the program, processes, methods, and systems described in this patent are not limited to any particular computer system or computer hardware.

The central processor 30 is typically a microprocessor. Advanced Micro Devices, Inc., for example, manufactures a full line of ATHLON™ microprocessors (ATHLON™ is a trademark of Advanced Micro Devices, Inc., One AMD Place, P.O. Box 3453, Sunnyvale, Calif. 94088-3453, 408.732.2400, 800.538.8450, www.amd.com). Sun Microsystems also designs and manufactures microprocessors (Sun Microsystems, Inc., 901 San Antonio Road, Palo Alto Calif. 94303, www.sun.com). The Intel Corporation manufactures microprocessors (Intel Corporation, 2200 Mission College Blvd., Santa Clara, Calif. 95052-8119, 408.765.8080, www.intel.com). Other manufacturers also offer microprocessors. Such other manufacturers include Motorola, Inc. (1303 East Algonquin Road, P.O. Box A3309 Schaumburg, Ill. 60196, www.Motorola.com), International Business Machines Corp. (New Orchard Road, Armonk, N.Y. 10504, (914) 499-1900, www.ibm.com), and Transmeta Corp. (3940 Freedom Circle, Santa Clara, Calif. 95054, www.transmeta.com). Those skilled in the art further understand that the program, processes, methods, and systems described in this patent are not limited to any particular manufacturer's central processor.

The preferred operating system is a UNIX®-based system (UNIX® is a registered trademark of The Open Group, 44 Montgomery Street, Suite 960, San Francisco, Calif. 94104, 415.374.8280, www.opengroup.org). Other operating systems, however, are also suitable. Such other operating systems would include WINDOWS® (WINDOWS® is a registered trademark of Microsoft Corporation, One Microsoft Way, Redmond Wash. 98052-6399, 425.882.8080, www.Microsoft.com). WINDOWS NT®, and Mac® OS (Mac® is a registered trademark of Apple Computer, Inc., 1 Infinite Loop, Cupertino, Calif. 95014, 408.996.1010, www.apple.com). Those of ordinary skill in the art again understand that the program, processes, methods, and systems described in this patent are not limited to any particular operating system.

The system memory device (shown as memory subsystem 24, flash memory 26, or peripheral storage device 28) may also contain an application program. The application program cooperates with the operating system and with a video display unit (via the serial port 46 and/or the parallel port 48) to provide a Graphical User Interface (GUI). The Graphical User Interface typically includes a combination of signals communicated along the keyboard port 42 and the mouse port 44. The Graphical User Interface provides a convenient visual and/or audible interface with a user of the computer system 22.

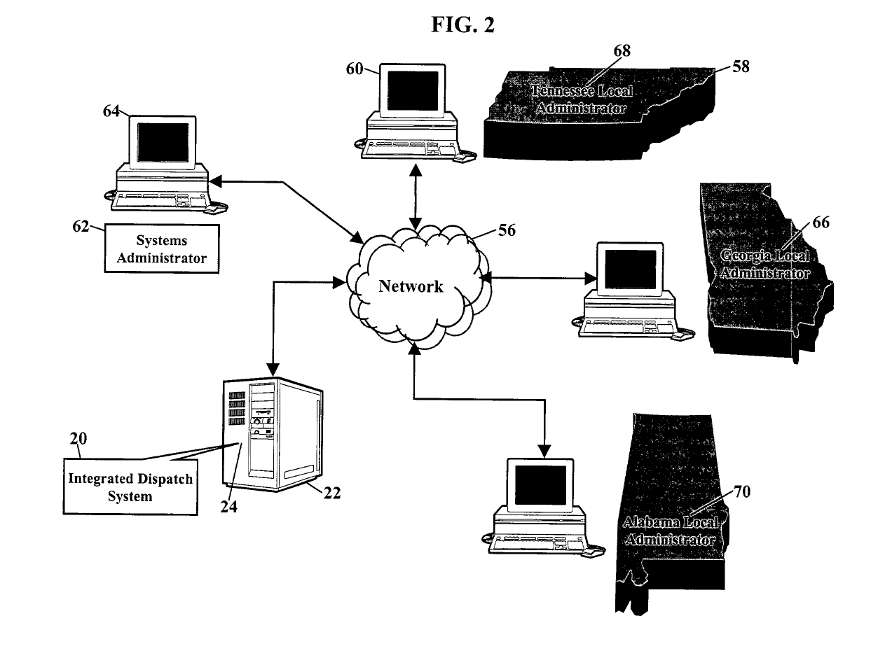

FIG. 2 is a schematic illustrating a further operating environment for the Integrated Dispatch System 20. As FIG. 2 shows, the Integrated Dispatch System 20 is a computer program that operates within the memory subsystem 24 of the computer system 22. (The Integrated Dispatch System 20, however, could also reside in flash memory 26 or peripheral storage device 28, shown, respectively, as reference numerals 26 and 28 in FIG. 1.) The Integrated Dispatch System 20 acquires information from a data network 56 using a data-transfer protocol (such as TCP/IP). The Integrated Dispatch System 20 then uses this information to dispatch a work order for maintenance of a telecommunications network. While there are several Integrated Dispatch Systems known in the art, the TELCORDIA™ FORCE™ Integrated Dispatch System is preferred (TELCORDIA™ and FORCE™ are trademarks of Telcordia Technologies, Inc., 445 South St., Morristown N.J. 07960, www.telcordia.com).

The Integrated Dispatch System 20 interfaces with one or more computer users. As FIG. 2 shows, one or more Local Administrators 58 use a computer 60 to access the Integrated Dispatch System 20 via the data network 56. One or more System Administrators 62, similarly, also use a computer 64 to access the Integrated Dispatch System 20 via the data network 56. The Integrated Dispatch System 20, however, includes different levels of security permissions to deter the Local Administrators 58 from intruding upon the authority of the System Administrators 62. A first level of security permissions, termed “Local Security Permissions,” applies to the Local Administrators 58. A higher, second level of security permissions, termed “System Security Permissions,” applies to the System Administrators 62.

The Local Security Permissions apply to the Local Administrators 58. The Local Security Pennissions permit a Local Administrator to modify data or parameters that are specific to the Local Administrator's geographic jurisdiction. The Local Security Permissions, however, deter, or even prevent, the Local Administrator from modifying data or parameters that are not specific to the Local Administrator's geographic jurisdiction. FIG. 2, for example, shows a Georgia Local Administrator 66 having authority for data and parameters pertaining to Georgia. A Tennessee Local Administrator 68 has authority for data and parameters pertaining to Tennessee, while an Alabama Local Administrator 70 has authority for data and parameters pertaining to Alabama. The Local Security Permissions permit the Georgia Local Administrator 66 to modify data and parameters that are specific to Georgia, yet the Local Security Permissions deter the Georgia Local Administrator 66 from modifying data that pertains to Tennessee or to Alabama. The Local Security Permissions, therefore, deter a Local Administrator from making any data or parameter modifications that are outside the Local Administrator's geographic jurisdiction and/or the responsibility of another administrator for another jurisdiction. The Local Security Permissions could apply to much smaller jurisdictions, such as counties, towns, or zones; yet, for simplicity and for recognition, state jurisdictional boundaries are used.

The System Administrator's authority, however, is cross-jurisdictional. The System Security Permissions permit the System Administrator 62 to modify data and parameters across geographic jurisdictions. The System Administrator 62, for example, may modify any data or parameters that pertain to Georgia, Tennessee, and/or Alabama. The System Security Permissions allow the System Administrator 62 to control system-wide Integrated Dispatch System data and parameters, as well as area-specific data and parameters across all jurisdictions. The System Security Permissions thus permit the System Administrator 62 to modify system-wide parameters that apply to one or more geographic jurisdictions.

These two different levels of security permissions reduce unwanted, system-wide modifications. Although many of the Integrated Dispatch System data and parameter fields are system-wide (that is, the parameter fields and data are common to all jurisdictions), the Local Security Permissions reduce the ability of a Local Administrator to make modifications outside the Local Administrator's jurisdiction. If a Local Administrator now makes a change to data or to parameters, that change will only affect the Local Administrator's jurisdiction. Georgia and Alabama, for example, will not be affected by a modification chosen by the Tennessee Local Administrator 68. Should a Local Administrator make an inadvertent or an incorrect change, the Local Security Permissions prevent that change from affecting areas beyond the Local Administrator's jurisdiction.

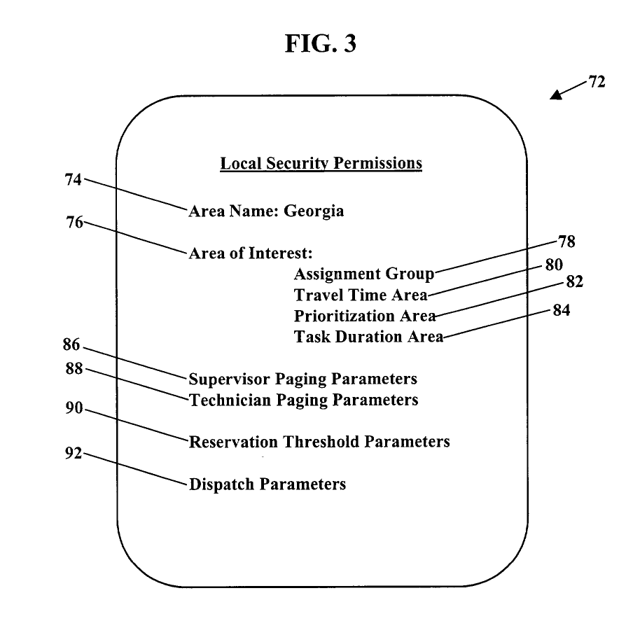

FIG. 3 is a Graphical User Interface showing the Local Security Permissions 72. The Local Security Permissions 72 permit a Local Administrator to modify data or parameters that are specific to the Local Administrator's geographic jurisdiction. Each Local Administrator is assigned a geographic jurisdiction. The geographic jurisdiction may be defined by an Area Name 74 and/or by an Area of Interest 76. The Area Name 74 preferably describes a Local Administrator's jurisdiction, such as “Georgia,” “Tennessee,” or “Alabama.” The Area of Interest 76 could include one or more assignment groups 78, one or more travel time areas 80, one or more prioritization areas 82, and one or more task duration areas 84. The term “Area of Interest” means a collection of assignment groups and/or turfs that represent a geographic area. The term “assignment group” means a geographic area containing one or more turfs. The term “travel time area” means a geographic area where travel time considerations are similar for the entire area. The term “prioritization area” means a geographic area where job types are “weighted” differently that the standard because of the area. The term “task duration area” means a geographic area where job types are weighted differently than the standard because the duration of the task.

The Local Security Permissions 72 may permit modification of paging parameters. These paging parameters define how a person is contacted using a pager communications device. The Local Security Permissions, for example, may permit a Local Administrator to modify a person's contact information. This contact information could include pager communication numbers, pager email addresses, and the hours the pager communications device is available to receive pager communications. Some people, for example, may not want to receive pager communications outside work hours, at night, or during weekends. The Local Security Permissions could permit modification of supervisor paging parameters 86 for a supervisor working in the Local Administrator's geographic jurisdiction. The Local Security Permissions could permit modification of technician paging parameters 88 for a technician working in the Local Administrator's geographic jurisdiction. The paging parameters define how the supervisor and/or the technician is contacted using a pager communications device, and the paging parameters define what conditions must occur before a supervisor or a technician is paged. Some administrators, for example, may have authority to page a technician on demand or at the administrator's discretion. Paging may be initiated according to the work order source system, the work type (inside or outside dispatch), the assignment group, and/or the turf A supervisor may be paged when an excess force or when an excess load condition exists. A supervisor may also be paged when a high-priority job cannot be assigned to a technician. A supervisor may also want to be paged when a technician has exceeded an estimated job duration time beyond a specified amount. The paging parameters establish what conditions trigger the paging feature and what technician or supervisor should be paged. The person's contact information could also include mobile phone numbers, email addresses, and home phone numbers.

The Local Security Permissions 72 may also permit modification of reservation threshold parameters 90. These reservation threshold parameters 90 define how a reservation is made for maintenance of the telecommunications system. The reservation threshold parameters 90 may reserve morning time slots for the previous night's high-priority job types. Outdoor repairs during the hot summer months may also be reserved for the morning time slots. The reservation threshold parameters may also be established to minimize travel time and fuel consumption.

The Local Security Permissions 72 may also permit modification of dispatch parameters 92. These dispatch parameters 92 define how a reservation is made for maintenance of the telecommunications system. The dispatch parameters 92, such as a “Dispatch Date Class,” categorize work requests. Dispatch dates are then assigned to these categories of work requests. Dispatch dates may also be assigned according to the assignment group.

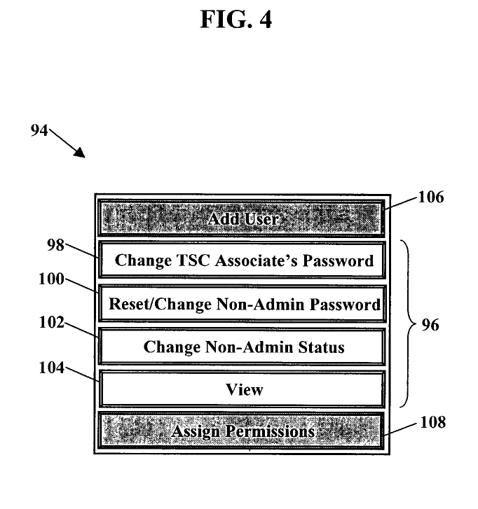

FIG. 4 is a schematic illustrating a Graphical User Interface 94 for a Technical Support Center associate. A Technical Support Center associate, among other things, has the responsibility of resetting passwords in the Integrated Dispatch System. If a user's password expires, the user cannot access the Integrated Dispatch System. While the Technical Support Center associate could have authority to reset the user's password, the Technical Support Center associate may not have broad access to the Integrated Dispatch System. FIG. 4, then, shows security permissions 96 for the Technical Support Center associate. The Graphical User Interface 94 displays four (4) choices from which the Technical Support Center associate may access. The Technical Support Center (TSC) associate may (i) change 98 their own password, (ii) reset/change 100 a non-systems administrator's password, (iii) change 102 whether a non-systems administrator has an active or inactive status, and (iv) simply view 104 data without making any changes to the data. These four (4) choices are the extent of the security permissions for the Technical Support Center associate. Any other choices, such as adding 106 a user to the Integrated Dispatch System or assigning 108 permissions to a user, are unavailable choices and appear “grayed out” in the Graphical User Interface 94. These security permissions 96 allow the Technical Support Center associate to troubleshoot passwords and status, but the security permissions 96 deter the Technical Support Center associate from making unintended changes to the Integrated Dispatch System.

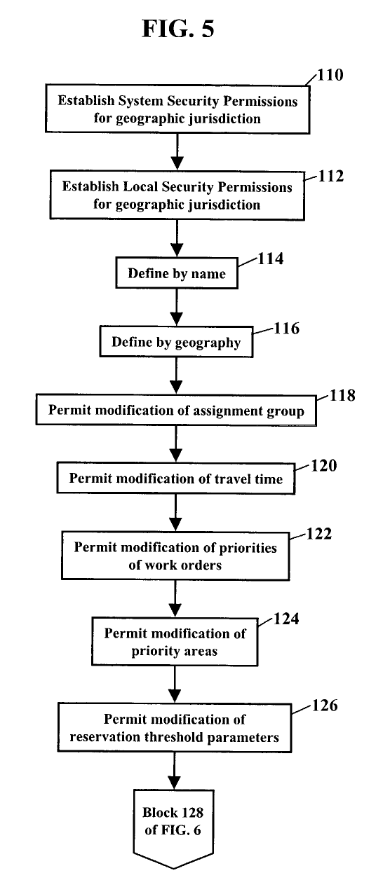

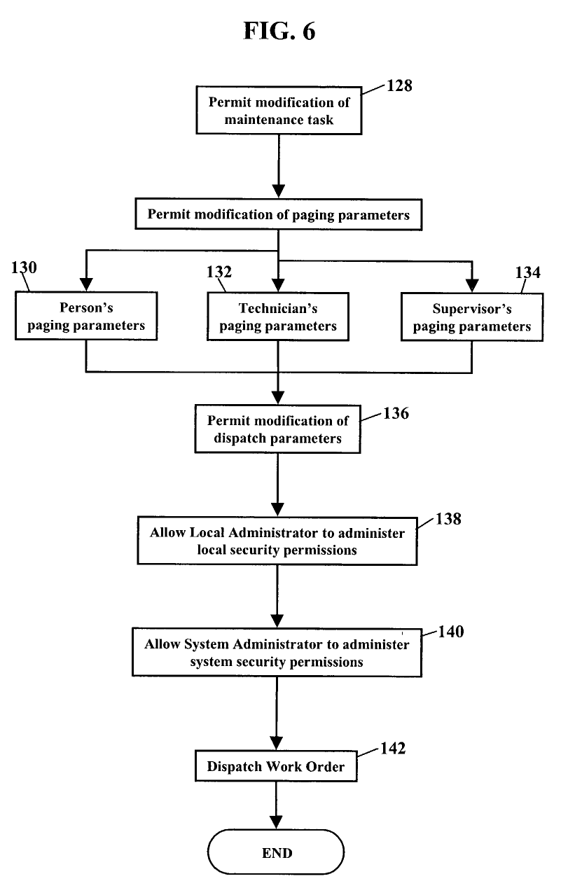

FIGS. 5 and 6 are flowcharts describing one method of enhancing an Integrated Dispatch System with security permissions. The Integrated Dispatch System manages dispatch of a work order for maintenance of a telecommunications system. System security permissions (Block 110) and local security permissions (Block 112) are established in the Integrated Dispatch System. The local security permissions permit modification of data specific to a geographic jurisdiction, while the local security permissions deter modification of data not specific to the geographic jurisdiction. The system security permissions permit modification of data across geographic jurisdictions. Once the local security permissions are established, the local security permissions may be defined by a name (Block 114) and/or by a geography (Block 116).

When the local security permissions are established and defined, the local security permissions permit modification of various data fields. The local security permissions, for example, may permit modification of an assignment group operating within the geographic jurisdiction (Block 118), a travel time within the geographic jurisdiction (Block 120), and/or priorities of work orders dispatched within the geographic jurisdiction (Block 122). The local security permissions may also permit modification of priority areas within the geographic jurisdiction (Block 124) and/or reservation threshold parameters (Block 126). The priority areas are those geographic areas where maintenance is a priority, and the reservation threshold parameters define how a reservation is made for maintenance of the telecommunications system.

The method continues in FIG. 6. The local security permissions may also permit modification of the duration of a maintenance task within the geographic jurisdiction (Block 128) and the modification of paging parameters for any person in the geographic jurisdiction (Block 130), including a technician (Block 132) or a supervisor (Block 134). The paging parameters define how the person is contacted using a pager communications device, such as a supervisor or a technician working in the geographic jurisdiction. The local security permissions may also permit modification of dispatch parameters (Block 136), with the dispatch parameters defining how the work order is dispatched for maintenance of the telecommunications system.

The security permissions may also correspond with administrative roles. The local security permissions are administered by a local administrator (Block 138), while the system security permissions are administered by a system administrator (Block 140). The local administrator has authority to modify the local security permissions that are specific to the local administrator's geographic jurisdiction. The system administrator has authority to modify the system security permissions across geographic jurisdictions. Once the local security permissions and the system security permissions are established, the Integrated Dispatch System continues to electronically dispatch the work order (Block 142).

The Integrated Dispatch System (shown as reference numeral 20 in FIG. 1), including the methods of the present invention, may be physically embodied on or in a computer-readable medium. This computer-readable medium may include CD-ROM, DVD, tape, cassette, floppy disk, memory card, and large-capacity disk (such as IOMEGA®, ZIP®, JAZZ®, and other large-capacity memory products (IOMEGA®, ZIP®, and JAZZ® are registered trademarks of Iomega Corporation, 1821 W. Iomega Way, Roy, Utah 84067, 801.332.1000, www.iomega.com). This computer-readable medium, or media, could be distributed to end-users, licensees, and assignees. These types of computer-readable media, and other types not mention here but considered within the scope of the this invention, allow the Integrated Dispatch System to be easily disseminated. A computer program product, providing two levels of security permissions, comprises the computer-readable medium and the Integrated Dispatch System. The Integrated Dispatch System is stored on the computer-readable medium.

While the present invention has been described with respect to various features, aspects, and embodiments, those skilled and unskilled in the art will recognize the invention is not so limited. Other variations, modifications, and alternative embodiments may be made without departing from the spirit and scope of the present invention. This invention, for example, has been described as enhancing the Integrated Dispatch System with two levels of security permissions. Those of ordinary skill in the art will now recognize that more than two levels of security permissions may be added to the Integrated Dispatch System. Security permissions could be established for particular tasks in maintaining the Integrated Dispatch System. Security permissions could also be established for particular functions in maintaining the Integrated Dispatch System. There could be many levels of security permissions, depending upon the levels of administrators, the authority of various administrators, and/or the location of an administrator. The security permissions may also correspond to root permissions in the UNIX® programming environment. It is, therefore, understood that this invention is not to be limited to the specific embodiments disclosed and that modifications and other embodiments are intended to be included within the scope of the appended claims.

What is claimed is:

1. A product, comprising:
an Integrated Dispatch System for managing the dispatch of work orders for maintenance of a telecommunications network, the Integrated Dispatch System having local security permissions and system security permissions;
the local security permissions permitting a local administrator to control local parameters that are specific to a geographic jurisdiction; and
the system security permissions permitting a system administrator to control system-wide parameters that apply to more than one geographic jurisdiction.

2. A method, comprising:
establishing local security permissions and system security permissions in an integrated dispatch system, the integrated dispatch system managing dispatch of a work order for maintenance of a telecommunications system;
the local security permissions permitting modification of data specific to a geographic jurisdiction, while the local security permissions deter modification of data not specific to the geographic jurisdiction;
the system security permissions permitting modification of data across geographic jurisdictions; and
dispatching the work order.

3. A method according to claim 2, further comprising defining the local security permissions by a name.

4. A method according to claim 2, further comprising the step of defining the local security permissions by a geography.

5. A method according to claim 2, wherein the local security permissions permit modification of an assignment group operating within the geographic jurisdiction.

6. A method according to claim 2, wherein the local security permissions permit modification of a travel time within the geographic jurisdiction.

7. A method according to claim 2, wherein the local security permissions permit modification of priorities of work orders dispatched within the geographic jurisdiction.

8. A method according to claim 2, wherein the local security permissions permit modification of priority areas within the geographic jurisdiction, the priority areas being those geographic areas where maintenance is a priority.

9. A method according to claim 2, wherein the local security permissions permit modification of a duration of a maintenance task within the geographic jurisdiction.

10. A method according to claim 2, wherein the local security permissions permit modification of paging parameters for a person in the geographic jurisdiction, the paging parameters defining how the person is contacted using a pager communications device.

11. A method according to claim 2, wherein the local security permissions permit modification of paging parameters for a supervisor working in the geographic jurisdiction, the paging parameters defining how the supervisor is contacted using a pager communications device.

12. A method according to claim 2, wherein the local security permissions permit modification of paging parameters for a technician working in the geographic jurisdiction, the paging parameters defining how the technician is contacted using a pager communications device.

13. A method according to claim 2, wherein the local security permissions permit modification of reservation threshold parameters, the reservation threshold parameters defining how a reservation is made for maintenance of the telecommunications system.

14. A method according to claim 2, wherein the local security permissions permit modification of dispatch parameters, the dispatch parameters defining how the work order is dispatched for maintenance of the telecommunications system.

15. A method according to claim 2, wherein the local security permissions are administered by a local administrator, the local administrator having authority to modify the local security permissions that are specific to the geographic jurisdiction.

16. A method according to claim 2, wherein the system security permissions are administered by a system administrator, the system administrator having authority to modify the system security permissions across geographic jurisdictions.

17. A system, comprising:
an integrated dispatch system stored in a memory device, the integrated dispatch system for managing dispatch of work orders in a telecommunications network, the integrated dispatch system having local security permissions and system security permissions;
the local security permissions permitting modification of data specific to a geographic jurisdiction, while the local security permissions deter modification of data not specific to the geographic jurisdiction;
the system security permissions permitting modification of data across geographic jurisdictions; and
a processor communicating with the memory device.
